(19) United States
(12) Patent Application Publication
(10) Pub. No.: US 2016/0225061 A1
(43) Pub. Date: Aug. 4, 2016

(54) PRODUCT MARKET LIFECYCLE DRIVEN RECOMMENDATIONS

(71) Applicant: International Business Machines Corporation, Armonk, NY (US)

(72) Inventors: Sheng Hua Bao, San Jose, CA (US); Sophia Krasikov, Katonah, NY (US); Shiwan Zhao, Beijing (CN)

(21) Appl. No.: 14/609,687

(22) Filed: Jan. 30, 2015

(51) Int. Cl. G06Q 30/06

(52) U.S. Cl. CPC G06Q 30/0631

(57) ABSTRACT

A method for recommending a product to a user based on a product's market lifecycle, whereby the recommendation is made in response to an indication from the user that a recommendation of an item would be useful is provided. The method may include assembling candidate recommendations from a plurality of recommendation sources, whereby the recommendation sources are configured to generate one or more product recommendations to the user based on a plurality of customer product preferences. The method may also include selecting at least one candidate from a plurality of product life cycle curves, whereby the selection is based on at least one time preference type associated with the user and a product life cycle position associated with one or more selected products.

### BACKGROUND

The present invention relates generally to the field of computers, and more particularly to recommendation systems.

Many on-line web stores use product recommendation systems that employ various recommendation methods. One common characteristic of such recommendation methods is that the recommendation method may steer customers to products that best meet the customer's needs and preferences. In other words, the recommendation systems try to find which products a customer wants and with which properties. Web stores may then collect and maintain data that the recommendation systems use in their methods. This data can include customers' transaction histories, information about customers' social networks, customers' profiles—location, age, marriage status, income, etc.

### SUMMARY

According to one embodiment, a method for recommending a product to a user based on a product market lifecycle, whereby the recommendation is made in response to an indication from the user that a recommendation of an item would be useful is provided. The method may include assembling candidate recommendations from a plurality of recommendation sources, whereby the recommendation sources are configured to generate one or more product recommendations to the user based on a plurality of customer product preferences. The method may also include selecting at least one candidate from a plurality of product life cycle curves, whereby the selection is based on at least one time preference type associated with the user and a product life cycle position associated with one or more selected products.

According to another embodiment, a computer for recommending a product to a user based on a product market lifecycle, whereby the recommendation is made in response to an indication from the user that a recommendation of an item would be useful is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include assembling candidate recommendations from a plurality of recommendation sources, whereby the recommendation sources are configured to generate one or more product recommendations to the user based on a plurality of customer product preferences. The method may also include selecting at least one candidate from a plurality of product life cycle curves, whereby the selection is based on at least one time preference type associated with the user and a product life cycle position associated with one or more selected products.

According to yet another embodiment, a computer program product for recommending a product to a user based on a market lifecycle associated with the product, whereby the recommendation is made in response to an indication from the user that a recommendation of an item would be useful is provided. The computer program product may include one or more computer-readable storage devices and program instructions stored on at least one of the one or me tangible storage devices, the program instructions executable by a processor. The computer program product may include program instructions to assemble candidate recommendations from a plurality of recommendation sources, whereby the recommendation sources are configured to generate one or more product recommendations to the user based on a plurality of customer product preferences. The computer program product may also include program instructions to select at least one candidate from a plurality of product life cycle curves, whereby the selection is based on at least one time preference type associated with the user and a product life cycle position associated with one or more selected products.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an exemplary illustration of the market lifecycle of different product categories according to at least one embodiment;

FIG. 3, is an exemplary illustration of a typical zip code level income distribution according to at least one embodiment;

FIG. 4, is an exemplary illustration of a system architecture according to at least one embodiment;

FIG. 5 is an operational flowchart illustrating the steps carried out by a program for providing product market lifecycle driven recommendations according to at least one embodiment;

FIG. 6, an exemplary illustration of a product recommendation based on the product's lifecycle according to at least one embodiment; and

FIG. 7 is a block diagram of internal and external components of computers and servers depicted in FIG. 1 according to at least one embodiment;

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to recommendation systems. The following described exemplary embodiments provide a system, method and program product to, among other things, recommend a product to a customer based on the product's position on its market lifecycle curve. Therefore, the present embodiment has the capacity to improve the technical field of marketing recommendation systems by providing product recommendations based on a product's market lifecycle. Furthermore, depending on a customer's profile attributes, such as income, lifestyle, and social status, a particular product may be attractive to a customer during different periods of the product's market lifecycle. As such, the present embodiment may enhance recommendation systems by providing a sales advantage that offers a customer products that reflect his/her time preference for a product.

As previously described, many on-line web stores use product recommendation systems that employ various recommendation methods. The recommendation systems may try to find which products a customer wants and with which properties. Web stores may then collect and maintain data that the recommendation systems use in their methods. This data can include customers' transaction histories, information about customers' social networks, customers' profiles—location, age, marriage status, income, etc.

Currently, there are three approaches used in recommendation systems:
1) Content-based recommendations: Recommendations similar to those which the user (i.e., customer) had preferred in the past;
2) Collaborative recommendations (i.e., collaborative filtering (CF)): The user is recommended an item which users with similar preferences liked in the past. The system predicts items for a particular user based on items previously rated by other users. The CF requires no domain knowledge and there is no need for extensive data collection.
3) Hybrid approach: Combining collaborative and content-based recommendations.

Additionally, rating and personal preferences, as feedback may be used in recommendation systems. Furthermore, recommendations may be based on predictive results suggesting products that users similar to the current user have purchased and which therefore may be of interest to the current user (e.g. [1, 2, 3]). Recommendations might also be based on the user's social network, the communities they belong to (e.g. [4, 5, 6, 7]). Finally, recommendations could be based on the user's location. ‘Location’ recommendations could be based on the products that have been purchased by the users in the same region or based on where the user is at that time now (e.g. [8, 9, 10]).

A variety of methods are known for making recommendations based on detecting customer behavior-based interests and associating them with products, such as behavior-based interests. Behavior-based interests could be inferred from customers' activities such as his/her purchases, dicks and selections, searches, ratings, wish lists, shopping carts, or combinations of such customer-based behavior. Using the behavior-based interests model, retailers would be able to exclude unnecessary (or redundant) recommendations from being offered. For example, a user's activity in the TV category, (e.g., viewing various TV models), may not be used to generate recommendations if the activity (browsing) occurred prior to the user's purchase of a TV. For example, once someone buys a TV, there is no need to recommend other TVs to them based on their browsing history.

Furthermore, in another known method, the plurality of purchase peak probabilities' is associated with a predicted likelihood of user interest in receiving recommendations based on a product type and a time-season factor, such as “season” products. For example, purchase volume for winter apparel will dramatically increase in the winter season; therefore recommendations of winter apparel will be more weighted in the appropriate months.

Additionally, there are known methods that group products into ‘popularity’ and ‘margin’ tiers. The popularity tiers indicate how popular the products are expected to be among customers. Each product is assigned to one of a number of margin tiers. The margin tiers indicate how much money a retailer makes in selling the products to the customers. Then by applying decision rules to the products in the tiers some products are selected to be put ‘On Sale’. Thus, grouping products into popularity and margin tiers may allow retailers to make decisions as to which products to discount or highlight for their whole customer base since these are not personalized recommendations.

However, no such method being used today makes a recommendation to a customer based on a product's market lifecycle. As such, it may be advantageous, among other things, to implement a method where a product recommendation is based on a product's market lifecycle in conjunction with a customer's profile attributes. Therefore, depending on a customer's profile attributes, such as transaction history, income, lifestyle, and social status, a particular product might be attractive in different periods of the products' market lifecycle.

According to at least one implementation, the present embodiment may identify a customer “timing” preference (i.e. when the customer prefers to purchase the product), such as at the beginning of product market lifecycle (early trend period); when the product grows in popularity (popular period); or when the product enters a mass or “mainstream” period (when it either becomes reasonably cheap, or can be put on sale due to trend's declining or leveling out). Furthermore, the present embodiment may use the following for finding “timing” recommendations:
Identification of the current position on the lifecycle curve of the product the customer can afford.
Identification of customer “timing” preference (when the customer wants to own the product—is he/she an early adopter of this product type, or someone who prefers to wait until it goes on sale?).
Identification of customer ability to afford the product.
Finding a right match between a customer and products to make recommendations.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product to provide a product recommendation to a user in response to an indication from the user that a recommendation on an item would be useful. According to at least one implementation, the present embodiment may assemble candidate recommendations from a group of recommendation sources configured to generate recommendations of items to users based on estimated of the user's preferred item attributed. As such, the present embodiment may position candidate recommendations from the group of recommendation sources on the product life cycle curves. Additionally, the present embodiment may select one or more candidates on product life cycle curves based on a customer's segment time preference or individual time preference. For example, the present embodiment may identify a customer “timing preference” (i.e., when a customer prefers to purchase a product), such as during an early trend period, a popular trend period, or a mass (i.e., mainstream) period when the product is cheaper.

According to at least one implementation of the present embodiment, the customer timing method may be identified by analyzing a customer's transaction history to find when he/she buys products in a particular category, when his/her social friends buy similar products, where the customer lives, his/her social and professional statuses, etc. To identify the range of his/her ability to afford a given product, the present embodiment may assess the customer's income, age, occupation, and purchasing habits. Furthermore, to find the position of the product on its market lifecycle curve, the present embodiment may analyze lifecycle curves in the product category.

Various implementations of the present embodiment may describe most product categories by using the log normal distribution curve:

$$fx ( x ; μ , σ ) = \frac{1}{x σ \sqrt{2 π}} {e}^{- \frac{{( ln x - μ )}^{2}}{2 {σ}^{2}}} , \\ x > 0$$

For example, x—is time the product is on the market, μ—is mean of the distribution, and σ—is standard deviation for a random process. In the present embodiment, μ and σ are the parameters that are needed to determine the best fit of the actual number of product sold at time x since that time that a product was first introduced on the market.

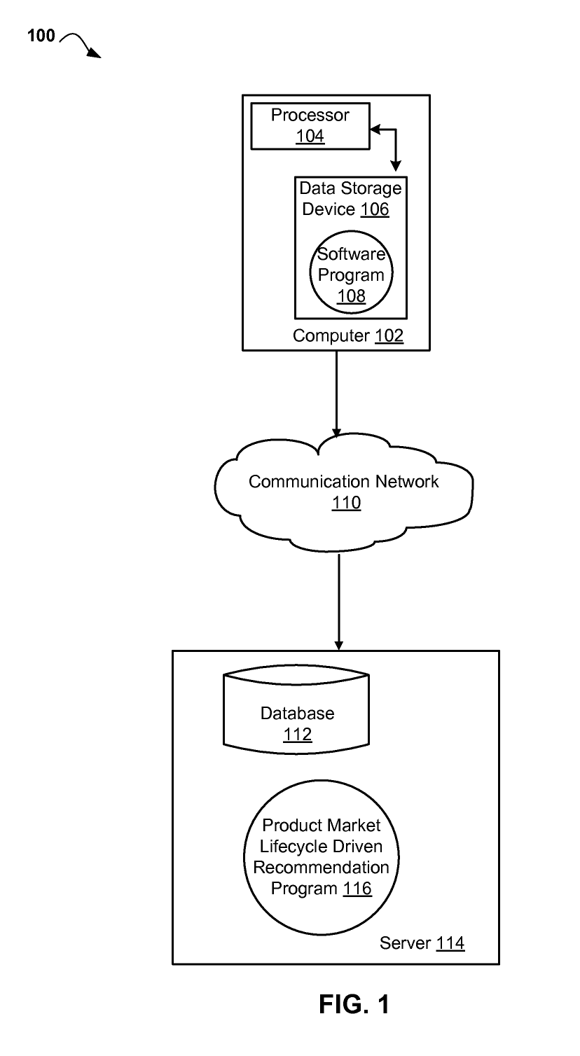

Referring to FIG. 1, an exemplary networked computer environment 100 in accordance with one embodiment is depicted. The networked computer environment 100 may include a computer 102 with a processor 104 and a data storage device 106 that is enabled to run a software program 108. The networked computer environment 100 may also include a server 114 that is enabled to run a Product Market Lifecycle Driven Recommendations Program 116 that interacts with a database 112, and a communication network 110. The networked computer environment 100 may include a plurality of computers 102 and servers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

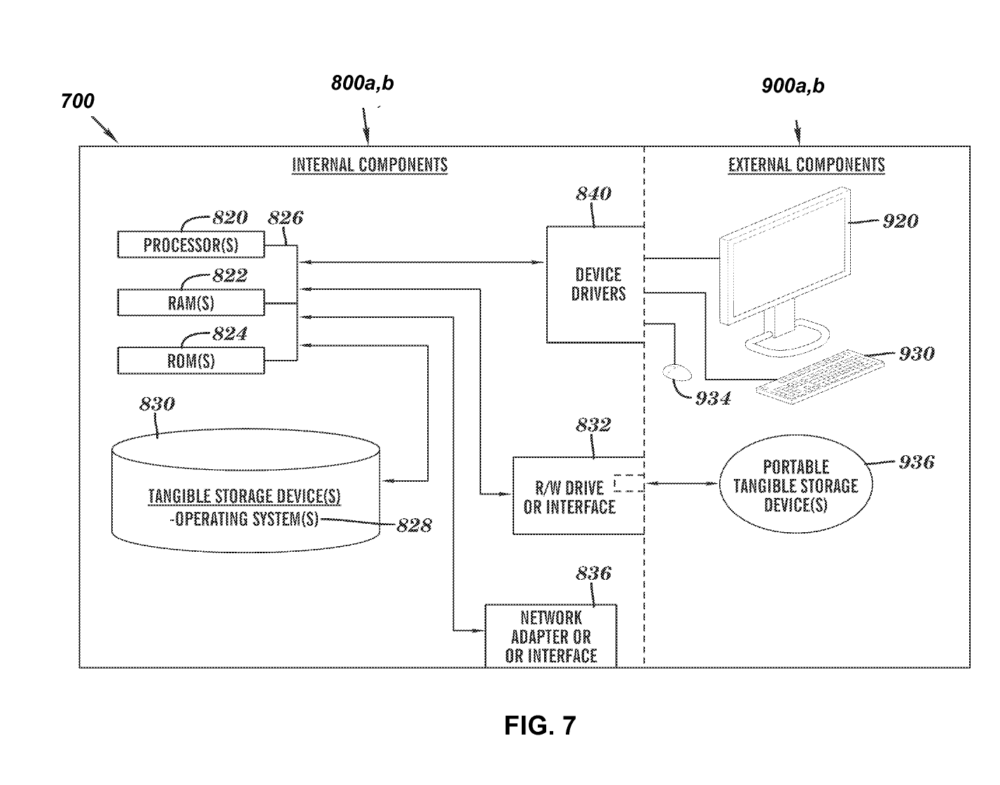

The client computer 102 may communicate with the Product Market Lifecycle Driven Recommendations Program 116 running on server computer 114 via the communications network 110. The communications network 110 may include connections, such as wire, wireless communication links, or fiber optic cables. As will be discussed with reference to FIG. 7, server computer 114 may include internal components 800a and external components 900a, respectively, and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing devices capable of running a program, accessing a network, and accessing a database 112.

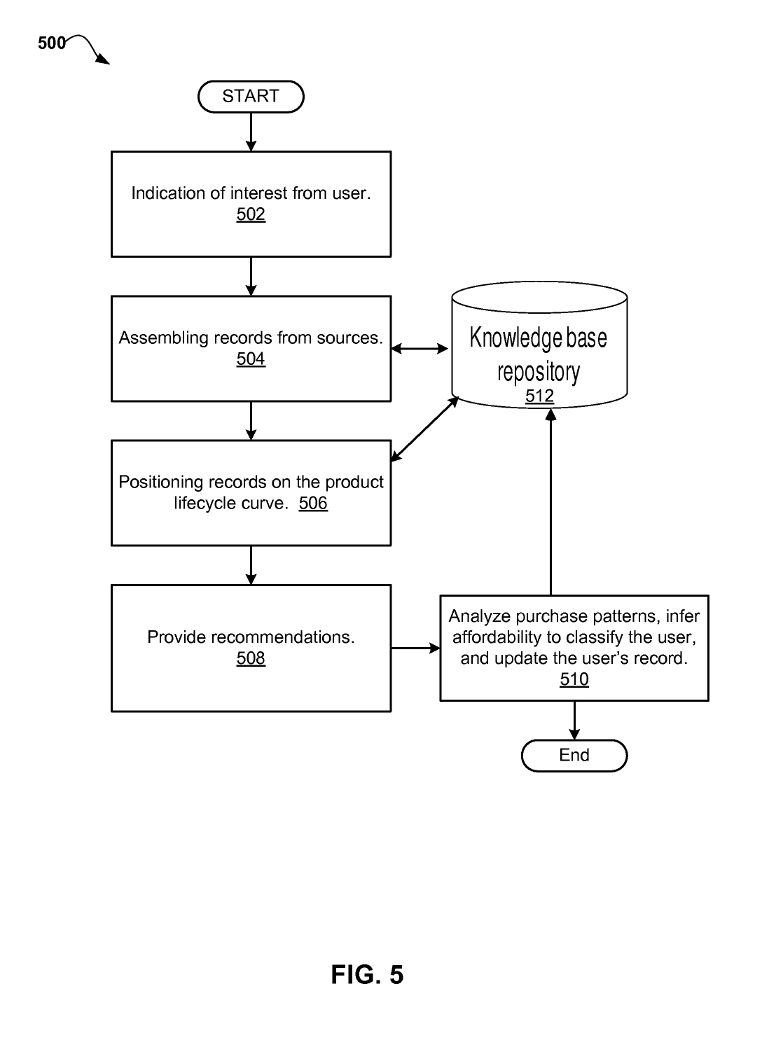

As previously described, the client computer 102 may access the Product Market Lifecycle Driven Recommendations Program 116, running on server computer 114 via the communications network 110. For example, a user (i.e., customer) using an application program 108 running on a client computer 102 may connect via a communication network 110 to database 112 or the Product Market Lifecycle Driven Recommendations Program 116 which may be running on server computer 114. As previously described, the Product Market Lifecycle Driven Recommendations Program 116 may provide a user (i.e., customer) with product recommendations based on product timing on the market (i.e., a product's market lifecycle) and the available customer's personal data. As such, the Product Market Lifecycle Driven Recommendations Program 116 running on server 114 may identify the customer's “timing” preference for a product's position and identify a customer's affordability of the product. Then, the Product Market Lifecycle Driven Recommendations Program 116 will find a match between the customer and products in order to make a recommendation to the customer as to which products they may be interested in purchasing. The Product Market Lifecycle Driven Recommendations method is explained in more detail below with respect to FIG. 5.

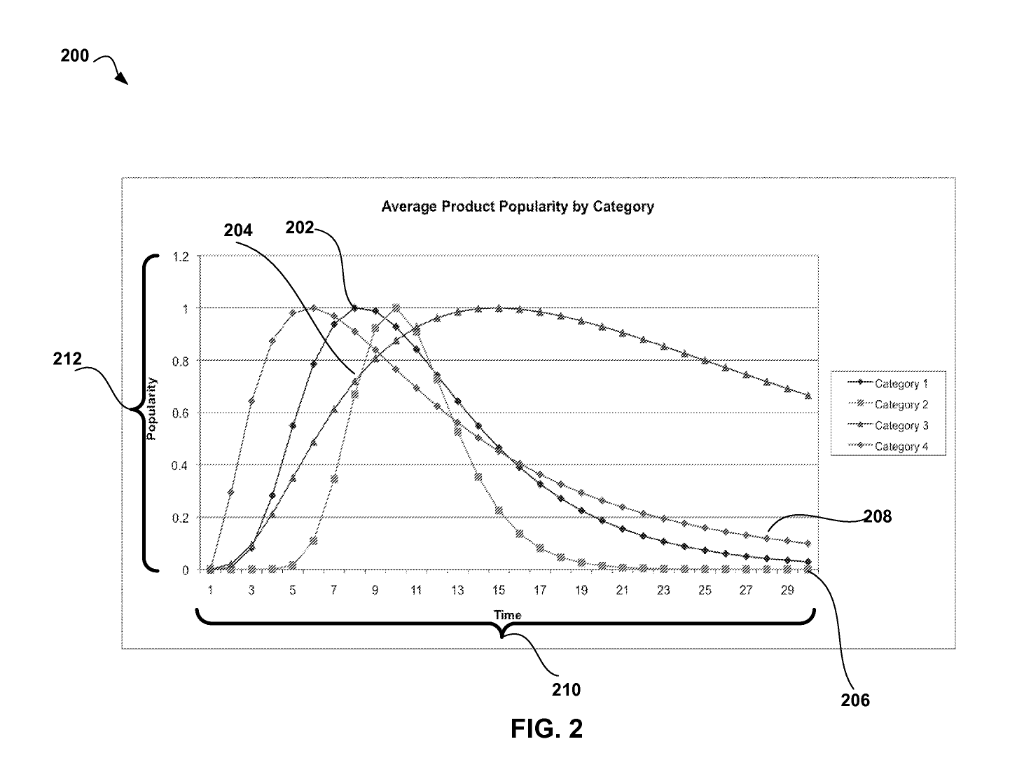

Referring now to FIG. 2, an exemplary illustration 200 of the market lifecycle of different product categories in accordance with one embodiment is depicted. The curves 202-208 depicted are normalized and represent product category averages. For all products in “Category 1” 202 for customers who prefer “trendy” products, the present embodiment may suggest a product in the first 6 weeks of when the product is on the market, assuming that Time 210 is given in weeks. For products in “Category 3” 204 (for customers who want “popular” 212 products), the present embodiment may suggest products which have been on the market between 10-25 weeks.

According to one implementation of the present embodiment, matching “customer—products” may include customer affordability range for a particular product category and the customer's product “timing” 210 preference. The low and high ends of the affordability range may be defined by multiple factors such as income, age, location, culture etc. For people who prefer trends, the present embodiment may identify and offer high end “aspiration” products—the ones that a consumer may not own at the moment because it is at the higher end of his/her price range and was not his/her priority purchase, but which the customer can nevertheless afford.

In one embodiment, an online retailer may wish to suggest a few “trendy”, high-end—“aspirational”, products to a customer when he or she searches for a product in a particular category 202-208. In consumer marketing, an aspirational product is one which a given customer may wish to own because 1) they believe it's of high quality 2) its popularity 212 will go up or remain high for a certain period of time 210 and 3) it will enhance his social standing.

In another embodiment, the retailer, rather than suggesting “most popular” products 212 (determined by volume of sales), may want to suggest not what's most popular now, but products that are rising in popularity 212. This may be especially useful when targeting an audience that seeks novelties and trends, which have not yet become “too popular” and are already on their way to becoming commodity products.

The derivative of a product's popularity (sales in a normalized form) curves 212 may in some cases be a more accurate indicator for a product's future popularity rather than how well it is presently selling. As such, making suggestions based on the derivative of a popularity curves 212 may better help retailers “surf the trend” of a product and suggest it when customers are most willing to pay the premium price for it.

Certain industries, such as fashion and beauty for example, operate according to a model by offering consumers a continually changing variety of brands and products. The lifecycle of a designer clothing item, for example, can be represented as a steep curve at the beginning when the popularity 212 of a new trend is rapidly rising, a rapid leveling out in the middle as the trendy product becomes a commodity product (which is no longer perceived as exclusive), and a down slope as the popularity of the commodity wanes with the introduction of new trends.

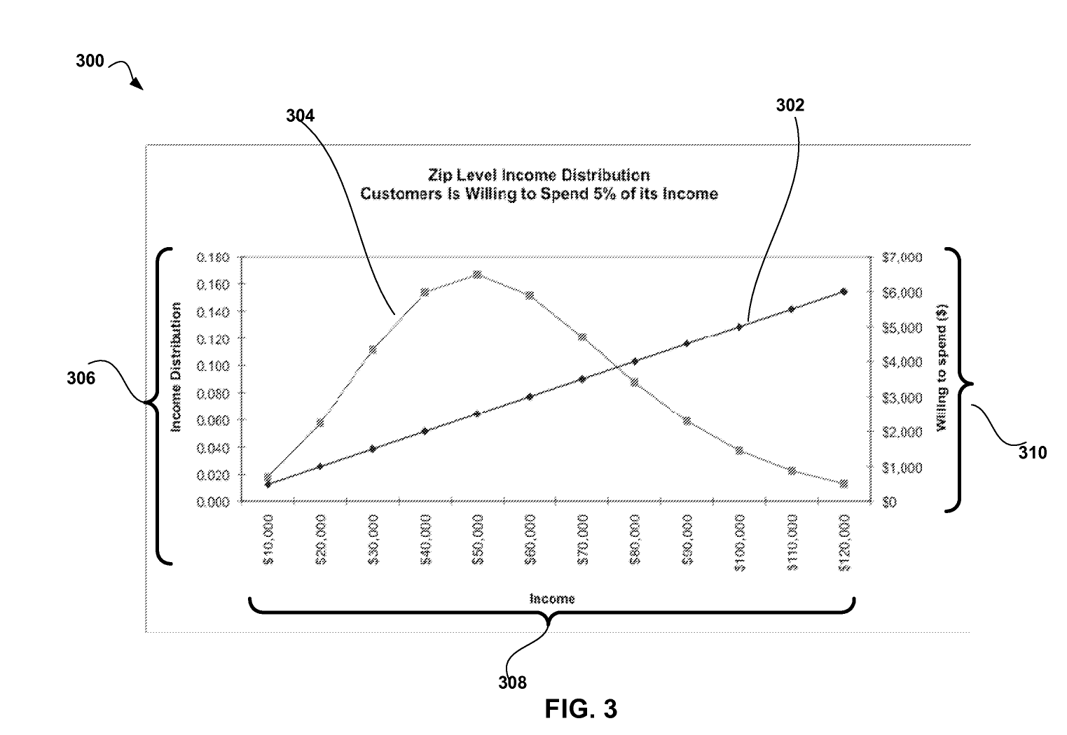

Referring now to FIG. 3, an exemplary illustration 300 of a typical zip code level income distribution in accordance with one embodiment is depicted. In an alternate embodiment, if the retailer is aware of only the zip code of the customer (due to the seller having limited information about the customer), the retailer may employ the distribution of customers' income 306 based on zip code. The individual income 308 could be then evaluated from the zip code income data adjusted by the customer's profile (transactional and browsing history etc.) if available. As such, the method may employ a mapping 302, 304 between a category and an average percentage of income (5% in this example) customers spend 310 on products in a category.

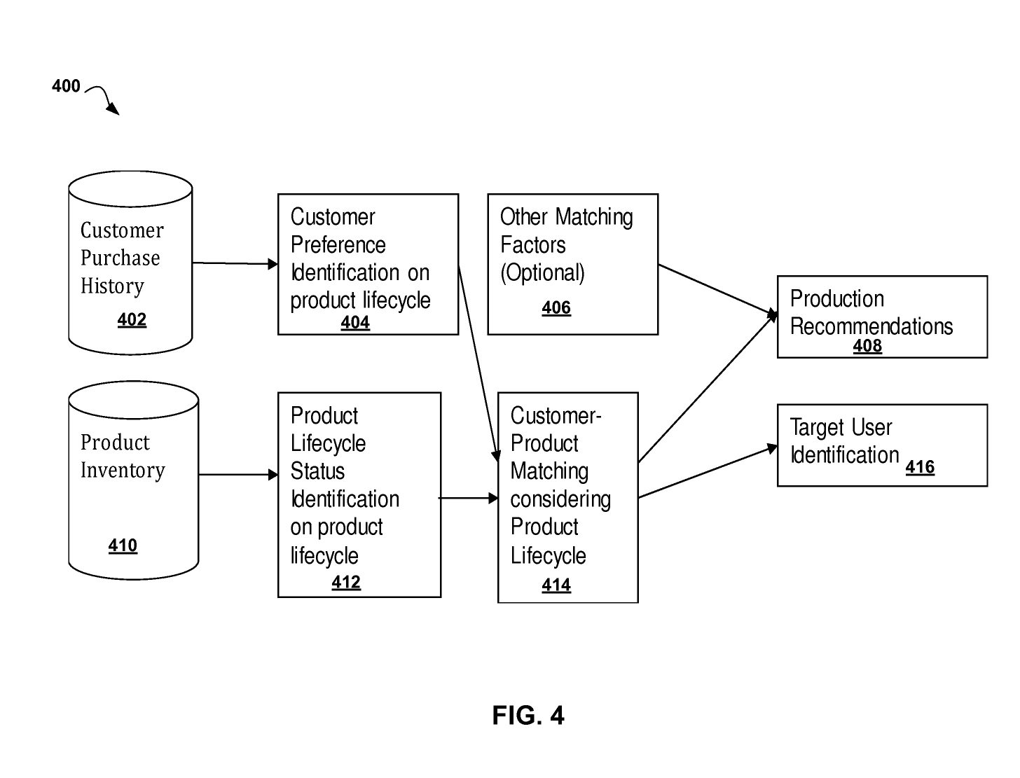

Referring now to FIG. 4, an exemplary illustration of a system architecture 400 in accordance with one embodiment is depicted. According to at least one implementation, the present embodiment may include the tracking of a customer purchase history that is stored in a repository 402. The Product Market Lifecycle Driven Recommendations Program 116 (FIG. 1) may include performing a customer preference identification on a product lifecycle 404 based on the tracked customer purchase history 402.

The present embodiment may also include the use of a product inventory repository 410 that may be used to perform the product lifestyle status identification on the product lifecycle 412. The Product Market Lifecycle Driven Recommendations Program 116 (FIG. 1) may perform product matching considering the product life cycle 414 by utilizing the previously determined customer preference identification on the product lifecycle 404 and the product lifecycle status identification on the product lifecycle 412.

Then, the Product Market Lifecycle Driven Recommendations Program 116 (FIG. 1) may present a customer with product recommendations 408 and target a user's identification 416 based on the customer product matching 414 and other optional matching factors 406.

Referring now to FIG. 5, an operational flowchart 500 illustrating the steps carried out by a program that provides product market lifecycle driven recommendations according to at least one embodiment is depicted. As previously described, the present embodiment may recommend products to a user based on a product's market lifecycle. The recommendation may be made based on the knowledge of a product's current position on the lifecycle curve of the product and identification of customer “timing” preference (i.e., customer timing type). Additionally, the present embodiment may also consider customer product preferences. As such, the present embodiment may assist in the decision to “buy now” and pay the premium for status or style versus “buy later” at a dollar discount for less status or style.

At 502, an indication of interest is received from a customer. Therefore, the Product Market Lifecycle Driven Recommendations Program 116 (FIG. 1) may receive an indication, such as a customer query of a product. As such, the customer query may indicate to the Product Market Lifecycle Driven Recommendations Program 116 (FIG. 1) that a recommendation of the queried item may be useful for the customer. For example, a customer may log into an E-commerce site and search for a particular product, such as a ‘digital camera’ which may indicate that a recommendation of digital cameras may be useful to the customer.

Then at 504, records are assembled from sources. Therefore, in response to the indication from the customer (in previous step 502) that a recommendation of an item would be useful, the Product Market Lifecycle Driven Recommendations Program 116 (FIG. 1) may assemble candidate recommendations from a group of recommendation sources, such as the knowledge base repository 512 which is configured to generate recommendations of products to customers based on estimates of customer preferred item attributes (i.e., customer product preferences). According to at least one implementation, the customer product preferences may be determined by one or more customer attributes, such as one of the following: zip code, location, income, age, cumulative purchase history, browsing history, prior on-line interaction with an e-store, web-store customer information, etc. As such, with respect to the above example, the Product Market Lifecycle Driven Recommendations Program 116 (FIG. 1) may assemble a variety of digital cameras based on estimates of the customer's preferred item attributes.

Next at 506, records are positioned on the product lifecycle curve. As such, the Product Market Lifecycle Driven Recommendations Program 116 (FIG. 1) may select one or more candidates on product lifecycle curves based on a customer segment time preference or a customer's time preference (i.e., a customer timing type) for a product and the product lifecycle position. According to at least one implementation, the customer timing type may be one or more of the following: early adapter customers who may pay a premium to be the first to have the item; popular/delayed customers who may be a combination of status and cost savings; and budget/bargain customers who may defer a purchase for a dollar discount. Furthermore, the customer timing type may be determined by customer attributes such as customer buying history or surveys.

Then at 508, recommendations are provided. Therefore, the Product Market Lifecycle Driven Recommendations Program 116 (FIG. 1) may present the customer (i.e., customer) with product recommendations based on the selected one or more candidates on product lifecycle curves from the previous step 506. According to at least one implementation of the present embodiment, the customer associated with the determined customer timing type from previous step 506 may be offered one or more products that are in a product life cycle that corresponds to the customer timing type. Additionally, the customer may be offered a discount on a product on the product life cycle that corresponds to the determined customer timing type. Furthermore, in at least one implementation, the seller may determine what part of the product lifecycle corresponds to one or more of the customer timing types.

Next at 510, purchase patterns are analyzed and affordability is inferred to classify the customer. As such, the Product Market Lifecycle Driven Recommendations Program 116 (FIG. 1) may analyze the purchase patterns of the user in order to infer affordability, classify the customer, and update the user's record.

It may be appreciated that FIG. 5 provides only an illustration of one implementation and does not imply any limitations with regard to how different embodiments may be implemented. Many modifications to the depicted environments may be made based on design and implementation requirements. For example, as previously described with respect to an alternate implementation, the present embodiment may identify a product's position on the product lifecycle curve and the seller may determine what part of the product lifecycle corresponds to one or more of the customer timing types. As such, the present embodiment may enable a seller to leverage a product's specific lifecycle curve for improving a buyer's personalized recommendation.

Additionally, according to another embodiment, the retailer can use survival analysis methods to model ‘time-on-the market’ for a product class as a function of customer segments (age, income, location etc). For example, if base line ‘time-on-the market’ is a function of a customer's age, then other customers attributes, such as income and location, are used as the model's adjusting multipliers. For a given customer, ‘time-on-the market’ may determine a customer's most-likely preference type, which is used for selecting product recommendation candidates on product life cycle curves. For example, the present embodiment may create segments for potential buyers of a product:
x1={F (30-40}; $70K-$120K, Location: downtown NYC}
x2={M(50-60}; $120K-$150K, Location: Houston, Tex.}
   As such, the method allows to find the average number of months of the product being on the market before purchasing for segment x1, x2 etc.

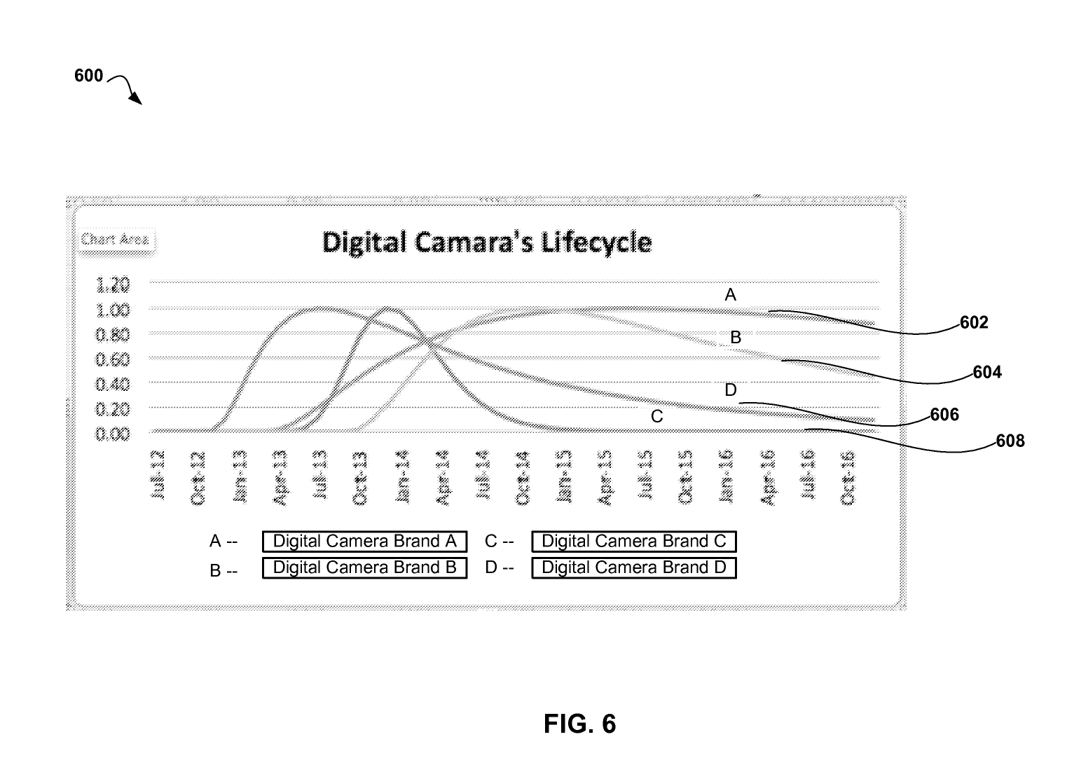

Referring now to FIG. 6, an exemplary illustration 600 of a product recommendation based on the product's lifecycle in accordance with one embodiment is depicted. A customer may log into an E-commerce site and search for a particular product, such as a ‘digital camera’. The retailer may then select four cameras, such as camera Brand A 602, camera Brand B 604, camera Brand C 608, and camera Brand D 606. According to at least one implementation of the present embodiment, in September of 2013, the Product Market Lifecycle Driven Recommendations Program 116 (FIG. 1) may present camera Brand C 608 and camera Brand A 602 to customers who prefer newly released products; camera Brand D 606 to a customer who prefers a product after the product has passed its peak; and camera Brand C 608 and camera Brand D 606 to budget customers with no preferences. Additionally, camera Brand C 608, camera Brand D 606, and camera Brand A 602 may be presented to a new customer with no profile statistics.

In April of 2014, the Product Market Lifecycle Driven Recommendations Program 116 (FIG. 1) may present camera Brand B 604 and camera Brand A 602 to customers who prefer newly released products; camera Brand C 608 and camera Brand D 606 to customers who prefer a product after the product has passed its peak; and camera Brand C 608, camera Brand D 606, and camera Brand B 604 to budget customers with no preferences. Additionally, all 4 cameras (i.e., camera Brand A 602, camera Brand B 604, camera Brand C 608, and camera Brand D 606) may be presented to a new customer with no profile statistics.

FIG. 7 is a block diagram 700 of internal and external components of computers depicted in FIG. 1 in accordance with an illustrative embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1) and network server 114 (FIG. 1) may include respective sets of internal components 800 a,b and external components 900 a,b illustrated in FIG. 6. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and the Software Program 108 (FIG. 1) in client computer 102 (FIG. 1) and the Product Market Lifecycle Driven Recommendations Program 116 (FIG. 1) in network server 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 7, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Product Market Lifecycle Driven Recommendations Program 116 (FIG. 1) can be stored on one or more of the respective portable computer-readable tangible storage devices 936, read via the respective R/W drive or interface 832 and loaded into the respective hard drive 830.

Each set of internal components 800 a,b also includes network adapters or interfaces 836 such as a TCP/IP adapter cards, wireless Wi-Fi interface cards, or 3G or 4G wireless interface cards or other wired or wireless communication links. The Software Program 108 (FIG. 1) in client computer 102 (FIG. 1) and the Product Market Lifecycle Driven Recommendations Program 116 (FIG. 1) in network server 114 (FIG. 1) can be downloaded to client computer 102 (FIG. 1) and network server 114 (FIG. 1) from an external computer via a network (for example, the Internet, a local area network or other, wide area network) and respective network adapters or interfaces 836. From the network adapters or interfaces 836, the Software Program 108 (FIG. 1) in client computer 102 (FIG. 1) and the Product Market Lifecycle Driven Recommendations Program 116 (FIG. 1) in network server 114 (FIG. 1) is loaded into the respective hard drive 830. The network may comprise copper wires, optical fibers, wireless transmission, routers, firewalls, switches, gateway computers and/or edge servers.

Each of the sets of external components 900 a,b can include a computer display monitor 920, a keyboard 930, and a computer mouse 934. External components 900 a,b can also include touch screens, virtual keyboards, touch pads, pointing devices, and other human interface devices. Each of the sets of internal components 800 a,b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for recommending a product to a user based on a product's market lifecycle, wherein the recommendation is made in response to an indication from the user that a recommendation of an item would be useful, the method comprising:
detecting an online customer query of the product;
in response to the detection of the online customer query of the product, accessing and analyzing an online transaction history associated with the user to determine when the user buys a plurality of products in a particular category, wherein the analyzing includes assessing an income associated with the user, assessing an age associated with the user, assessing an occupation associated with the user, and assessing a plurality of purchasing habits associated with the user;
analyzing a plurality lifecycle curves in a product category associated with the product;
assembling candidate recommendations from a plurality of recommendation sources, wherein the recommendation sources are configured to generate at least one product recommendation to the user based on the analysis of the online transaction history associated with the user, the analysis of the plurality of lifecycle curves in the product category, and a plurality of customer product preferences, wherein the plurality of customer product preferences are determined by the assessed zip code associated with the user, a location associated with the user, the assessed income associated with the user, the assessed age associated with the user, a cumulative purchase history associated with the user, a plurality of prior on-line interaction with an e-store, a plurality of web-store customer information, and a browsing history associated with the user; and
selecting one or more candidates on product life cycle curves from the assembled candidate recommendations, wherein the selection is based on at least one time preference type associated with the user and a current product life cycle position associated with one or more candidate products;
presenting the selected one or more candidates to the user, wherein the presented selected one or more candidates is offered at a discount.

2. The method of claim 1, wherein the user's time preference type comprises at least one of an early adapter user, a popular user or a delayed user, and a budget user or a bargain user.

3. (canceled)

4. The method of claim 1, wherein the user's time preference is determined by at least one of a customer buying history and a plurality of surveys.

5. The method of claim 1, further comprising:
offering the at least one selected product to the user.

6. The method of claim 5, wherein the at least one selected product is offered at a discount.

7. The method of claim 1, wherein a seller determines a part of the product life cycle curve that corresponds to the at least one time preference type associated with the user.

8. The method of claim 7, wherein the seller uses a plurality of survival analysis methods to model ‘time-on-the market’ for a product class as a function of a plurality of customer segments.

9. A computer system for recommending a product to a user based on a product's market lifecycle, wherein the recommendation is made in response to an indication from the user that a recommendation of an item would be useful, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
detecting an online customer query of the product;
in response to the detection of the online customer query of the product, accessing and analyzing an online transaction history associated with the user to determine when the user buys a plurality of products in a particular category, wherein the analyzing includes assessing an income associated with the user, assessing an age associated with the user, assessing an occupation associated with the user, and assessing a plurality of purchasing habits associated with the user;
analyzing a plurality lifecycle curves in a product category associated with the product;
assembling candidate recommendations from a plurality of recommendation sources, wherein the recommendation sources are configured to generate at least one product recommendation to the user based on the analysis of the online transaction history associated with the user, the analysis of the plurality of lifecycle curves in the product category, and a plurality of customer product preferences, wherein the plurality of customer product preferences are determined by the assessed zip code associated with the user, a location associated with the user, the assessed income associated with the user, the assessed age associated with the user, a cumulative purchase history associated with the user, a plurality of prior on-line interaction with an e-store, a plurality of web-store customer information, and a browsing history associated with the user; and
selecting one or more candidates on product life cycle curves from the assembled candidate recommendations, wherein the selection is based on at least one time preference type associated with the user and a current product life cycle position associated with one or more candidate products;
presenting the selected one or more candidates to the user, wherein the presented selected one or more candidates is offered at a discount.

10. The computer system of claim 9, wherein the user's time preference type comprises at least one of an early adapter user, a popular user or a delayed user, and a budget user or a bargain user.

11. (canceled)

12. The computer system of claim 9, wherein the user's time preference is determined by at least one of a customer buying history and a plurality of surveys.

13. The computer system of claim 9, further comprising:
offering the at least one selected product to the user.

14. The computer system of claim 13, wherein the at least one selected product is offered at a discount.

15. The computer system of claim 9, wherein a seller determines a part of the product life cycle curve that corresponds to the at least one time preference type associated with the user.

16. The computer system of claim 15, wherein the seller uses a plurality of survival analysis methods to model ‘time-on-the market’ for a product class as a function of a plurality of customer segments.

17. A computer program product for recommending a product to a user based on a product's market lifecycle, wherein the recommendation is made in response to an indication from the user that a recommendation of an item would be useful, the computer program product comprising:
one or more computer-readable storage devices and program instructions stored on at least one of the one or more tangible storage devices, the program instructions executable by a processor, the program instructions comprising:
program instructions to detect an online customer query of the product;
in response to the detection of the online customer query of the product, program instructions to access and analyze an online transaction history associated with the user to determine when the user buys a plurality of products in a particular category, wherein the analyzing includes assessing an income associated with the user, assessing an age associated with the user, assessing an occupation associated with the user, and assessing a plurality of purchasing habits associated with the user;
program instructions to analyze a plurality lifecycle curves in a product category associated with the product;
program instructions to assemble candidate recommendations from a plurality of recommendation sources, wherein the recommendation sources are configured to generate at least one product recommendation to the user based on the analysis of the online transaction history associated with the user, the analysis of the plurality of lifecycle curves in the product category, and a plurality of customer product preferences, wherein the plurality of customer product preferences are determined by the assessed zip code associated with the user, a location associated with the user, the assessed income associated with the user, the assessed age associated with the user, a cumulative purchase history associated with the user, a plurality of prior on-line interaction with an e-store, a plurality of web-store customer information, and a browsing history associated with the user; and
program instructions to select one or more candidates on product life cycle curves from the assembled candidate recommendations, wherein the selection is based on at least one time preference type associated with the user and a current product life cycle position associated with one or more candidate products;
presenting the selected one or more candidates to the user, wherein the presented selected one or more candidates is offered at a discount.

18. The computer program product of claim 17, wherein the user's time preference type comprises at least one of an early adapter user, a popular user or a delayed user, and a budget user or a bargain user.

19. (canceled)

20. The computer program product of claim 17, wherein the user's time preference is determined by at least one of a customer buying history and a plurality of surveys.
